(19) United States
(12) Patent Application Publication
(10) Pub. No.: US 2018/0231098 A1
(43) Pub. Date: Aug. 16, 2018

(54) CENTRIFUGAL FORCE PENDULUM DEVICE

(71) Applicant: Schaeffler Technologies AG & Co. KG, Herzogenaurach (DE)

(72) Inventors: Toros Güllük, Lichtenau (DE); Stephan Maienschein, Baden-Baden (DE)

(73) Assignee: Schaeffler Technologies AG & Co. KG, Herzogenaurach (DE)

(21) Appl. No.: 15/750,246

(22) PCT Filed: Aug. 10, 2016
(86) PCT No.: PCT/DE2016/200369

§ 371 Date: Feb. 5, 2018

(30) Foreign Application Priority Data
Aug. 11, 2015 (DE) 102015215269.3

(51) Int. Cl. F16F 15/14

(52) U.S. Cl. CPC F16F 15/145

(57) ABSTRACT

A centrifugal force pendulum device comprising a pendulum carrier including a first pendulum flange and a second pendulum flange rotatable around a rotational axis and arranged axially opposite each other is provided. A pendulum element is disposed axially between the first pendulum flange and the second pendulum flange. A connector is configured to fixedly connect the pendulum element to the first and second pendulum flanges of the pendulum carrier.

### CROSS-REFERENCE TO RELATED APPLICATIONS

This application is the U.S. National Phase of PCT Appln. No. PCT/DE2016/200369 filed Aug. 10, 2016, which claims priority to German Application No. 10 2015 215 269.3 filed Aug. 11, 2015, the entire disclosures of which are incorporated by reference herein.

### TECHNICAL FIELD

The present disclosure relates to a centrifugal force pendulum device with pendulum elements which are rotatable around a rotational axis.

### BACKGROUND

Centrifugal force pendulums and their devices are sufficiently known from drive trains of motor vehicles. In this case, a pendulum unit, for example in the form of a pendulum mass carrier, is mounted in a radially fixed and rotatable manner around a rotational axis for example of a crankshaft of an internal combustion engine, an input shaft of a transmission, or the like. Arranged on the pendulum mass carrier in a distributed manner over the circumference and axially at a distance from said pendulum mass carrier are pendulum elements such as pendulum masses which are suspended in an oscillatory manner in relation to the pendulum mass carrier in a plane which is perpendicular to the rotational axis and to this end form a second pendulum unit. As a result of this oscillating suspension, the pendulum masses form a rotational speed-adaptive torsional oscillation damper in the centrifugal force field of the rotating pendulum mass carrier by the pendulum masses extracting energy from the drive train by corresponding deflection during torque peaks and by feeding energy to the drive train during torque minimums.

For example—as known from WO2014/082629 A1—the pendulum masses can be arranged axially between two side parts, which form the pendulum mass carrier, in a distributed manner over the circumference. The side parts are interconnected in this case by means of connecting means. Alternatively—as known from DE 10 2012 221 949 A1—pendulum elements can be arranged on both sides of the pendulum mass carrier. Axially opposite pendulum elements are in this case interconnected by means of connecting means, forming pendulum masses, wherein the connecting means correspondingly pass through cut out recesses of the pendulum mass carrier.

A centrifugal force pendulum—as disclosed for example with reference to the aforesaid printed documents WO2014/082629 A1, DE 10 2012 221 949 A1—can be provided on a single mass flywheel, for example on a single mass flywheel which is produced from sheet metal. As known for example from printed documents WO2014/023303 A1 and DE 10 2013 201 981 A1, one or more centrifugal force pendulums can be provided on a torsional oscillation damper, on a clutch plate, corresponding to printed document WO2014/114280 A1, on a hydrodynamic torque converter, corresponding to printed document EP 2 600 030 A1, on a housing of a friction clutch or at similar points of the drive train. In this case, the isolation effect is dependent on the mass of the pendulum masses in addition to the oscillation angle. The spatial design is limited by the predetermined installation space of the centrifugal force pendulum.

### SUMMARY

The object of the present disclosure is the development of a centrifugal force pendulum device. The object of the disclosure is particularly to increase the isolation effect of the centrifugal force pendulum device. The object of the disclosure is particularly to reduce the installation space of the centrifugal force pendulum device. The object of the disclosure is particularly to reduce the number of components which are used.

The proposed centrifugal force pendulum device contains pendulum elements which are rotatable around a rotational axis and are in an axially layered arrangement. Depending on the function of these pendulum elements, these are arranged in a radially fixed manner in relation to the rotational axis and form a carrier such as a pendulum mass carrier. A single pendulum element can form a carrier. Further pendulum elements form pendulum masses which in relation to the rotational axis can be relatively displaced, for example radially and/or circumferentially. A plurality of these pendulum elements are arranged in a distributed manner over the circumference and are mounted on the carrier. Regardless of this division into radially fixed and radially displaceable pendulum elements, at least two axially opposite pendulum elements are interconnected by means of connecting means, forming a first pendulum unit, and at least one pendulum mass element forms a second pendulum unit which is arranged axially between the pendulum elements of the first pendulum unit. The connecting elements pass through recesses of the second pendulum unit.

The mounting of the displaceable pendulum elements on the radially fixed pendulum element(s) is carried out by means of at least one pendulum bearing. The corresponding pendulum elements which are mounted with oscillation capability, such as pendulum masses, are in this case suspended on the carrier eccentrically to the rotational axis in an oscillatory manner for example by means of the pendulum bearings under the effect of the centrifugal force field of this carrier rotating around the rotational axis and under the effect of centrifugal force occupies its working position which is unbalanced as a result of torsional oscillations, absorbing energy, so that a damping effect occurs. The at least one pendulum bearing, preferably two circumferentially spaced apart pendulum bearings, per radially displaceable pendulum unit develop in this case a predetermined pendulum movement which can be configured in the shape of an arc or in almost any other shape, for example can be different from the arc shape, for example can be provided with a reduced radius at the end, such that impacts of the pendulum masses at the maximum oscillation angles are unlikely. The pendulum bearings are formed on the one hand by pendulum roller tracks on the connecting means and on the other hand by pendulum roller tracks which are arranged on the second pendulum unit, wherein in each case a rolling body, for example a pendulum roller, rolls on the pendulum roller tracks per pendulum bearing.

Due to the type and design of the running tracks, the suspension of the pendulum masses is carried out in the simplest case in the sense of a simple pendulum. It has proved to be advantageous, however, to suspend the pendulum masses in each case on the carrier in a bifilar manner on two circumferentially spaced apart pendulum bearings. In this case, a pendulum movement corresponding to a parallel arrangement of the pendulum threads can be provided. Preferably, a pendulum guiding corresponding to a trapezoidal arrangement of the pendulum threads is proposed, in which the pendulum masses additionally execute a self-rotation during the pendulum movement so that additional inertia and therefore an improved isolation effect can be provided.

According to an advantageous embodiment, the first pendulum unit is formed from two side parts which are arranged in a radially fixed manner around the rotational axis and interconnected by means of the connecting means. The side parts form pendulum flanges, produced for example from sheet metal, which in one pendulum section are axially spaced apart. Arranged in this pendulum section, distributed over the circumference, are pendulum elements for example in the form of pendulum masses which in total form the second pendulum unit. The pendulum masses are mounted on the side parts for example by means of two circumferentially spaced apart pendulum bearings. The side parts are axially spaced apart in a fixed manner by means of the connecting means, wherein the connecting means pass through recesses of the pendulum masses and running tracks are machined on the connecting means at the axial height of the pendulum masses. Complementary running tracks, which are radially opposite the running tracks of the connecting means, are formed on the recesses. A rolling body, for example a pendulum roller, rolls between the running tracks.

In an alternative embodiment of the centrifugal force pendulum device, the second pendulum unit is formed from a pendulum flange which is arranged in a radially fixed manner around the rotational axis. Arranged on the pendulum flange in this case is the first pendulum unit which is formed from pendulum elements, such as pendulum masses, which are distributed on both sides on the pendulum flange and over the circumference. In each case two axially opposite pendulum masses are connected in this case by means of one or two connecting means which pass through recesses of the pendulum flange, wherein according to the disclosure the connecting means and the recesses form running tracks which are complementary to each other and on which rolls a rolling body, for example a pendulum roller.

In order to ensure the orientation of the running tracks in relation to each other, the connecting means are introduced into the pendulum elements with angular accuracy. To this end, the end faces of the connecting means can be introduced axially into corresponding openings, where round openings can enable a rotation before the fixing of a set angle. It has been shown to be advantageous if the openings and the end faces are designed to complement each other in a triangular, quadrangular or polygonal manner so that an angular position of the connecting means in relation to the pendulum elements is already fixed with angular accuracy during the joining of these.

The joining process between the connecting means and the relevant pendulum elements is carried out by the connecting means being connected in each case at the ends to the pendulum elements in a frictionally engaging, form-fitting or materially bonding manner.

According to an advantageous embodiment of the centrifugal force pendulum device, the pendulum units which can be displaced in an oscillatory manner have a greater material thickness than the pendulum units which are of a radially fixed design in relation to the rotational axis. As a result of this, the overall mass of the centrifugal force pendulum device is reduced and the damping mass proportion of the centrifugal force pendulum device is increased so that with the same axial installation space the oscillation isolation can be improved or with reduced axial installation space the oscillation isolation can be at least maintained.

As a result of the relocation of the running tracks into the connecting means, the hardness of the associated pendulum elements can be designed in such a way that the pendulum elements which are interconnected by the connecting means have a lower hardness than the connecting means. This means that a hardening, especially a surface hardening, can be limited to the connecting means. Furthermore, the pendulum elements which are interconnected by the connecting means can have a lower rigidity than the connecting means. For example, materials with lower strength than the strength of the connecting means and especially with lower strength than strengths customarily required for pendulum masses or carriers, such as pendulum flanges, can be used for this purpose.

In order to limit the oscillation angles of the pendulum units against each other, for example an oscillation angle of the pendulum masses in relation to the carrier under the influence of torque peaks, provision can be made between the connecting means and the second pendulum unit for stops which limit an oscillation angle of the pendulum units against each other. In order to avoid hard impacts, the stops can have elastic damping elements.

In other words, the object is achieved by an exemplary embodiment of a centrifugal force pendulum with two axially spaced apart pendulum flanges which are arranged in a radially fixed manner around the rotational axis and axially accommodate the pendulum masses between them. Provision can also be made for a single, for example annular, pendulum mass. The object is achieved by the provision of the two functions—the interconnecting of the pendulum flanges on the one hand and the provision of the pendulum track on the other hand—in one and the same element. The pendulum flanges which are arranged on both sides of the pendulum masses and carry the pendulum masses are connected with the aid of connecting means, such as a connecting element, which in each case is extended through a cutout or recess of the pendulum mass.

In its region which lies axially between the pendulum flanges, such as a pendulum section, a running track, such as a pendulum roller track, is incorporated into the connecting element. This pendulum roller track on the connecting element is oppositely disposed to a running track, such as a pendulum roller track, which is associated with the pendulum flanges so that the pendulum roller tracks which are connected to the pendulum flanges axially overlap with the pendulum roller tracks of the pendulum mass. The rolling body, such as a pendulum roller, which imparts a relative movement of the pendulum mass in relation to the pendulum flanges is arranged between the pendulum roller tracks of the connecting element and the pendulum mass.

Since the pendulum flanges themselves do not provide roller tracks, and therefore are not subjected to the high surface pressure of the rolling pendulum rollers, the pendulum flanges can be designed with a reduced material thickness in order to therefore achieve a further installation space reduction, and/or to produce these from a more cost-effective material with lower strength and/or hardness.

The handling of the small connecting element for the production of the pendulum roller track with suitable strength and hardness is simpler than the handling of the pendulum flanges for the same purpose.

The gain in installation space by reducing the material thickness of the pendulum flanges can also be partially or totally utilized when required in order to increase the masses of the pendulum masses and therefore the restoring force of the centrifugal force pendulum by the selection of greater material thicknesses of the pendulum masses.

A further possible advantage also exists in the reduction of the overall mass inertia moment of the centrifugal force pendulum since the mass inertia moments of the components which do not serve for increasing the restoring force can be reduced in a targeted manner for example by saving of the connecting elements and by reducing the sheet thicknesses of the pendulum flanges.

A further advantage results from the shortening of the pendulum roller length since the pendulum roller rolls on the same axial region of the pendulum roller shell both on the roller track which is connected to the pendulum flange and on the roller track which is connected to the pendulum mass and only needs to have the axial length of the wider pendulum roller track of the pendulum mass and the connecting element.

Since the pendulum rollers are arranged between two pendulum flanges no special measures have to be adopted in order to secure the pendulum rollers in the axial direction.

The ends of the connecting element can be connected in each case to a pendulum flange by pressing into openings, such as cutouts, of the pendulum flanges which are correspondingly provided for this. Alternatively, the end of the connecting element, which is pushed in or pushed through the cutout of the pendulum flange, can be connected by its end region to the pendulum flange by means of a welded joint. To this end, it can be provided that the cutout in the pendulum flange which accommodates the end of the connecting element is widened on its side facing the end-face end region of the connecting element for accommodating the weld material.

Alternatively, in the case of selecting a combined push-in and riveted connection or push-in and caulked joint as a connecting possibility, such a widening serves for accommodating a rivet head, which is formed from the end region of the end of the connecting element, or for accommodating displaced caulking material. A further possibility of producing a caulked joint is a local plastic deformation, preferably in the pendulum flanges, and a displacement of the material into an undercut of the connecting element, for example a notch, as a result of which an axial securing is achieved.

The connecting element, on the sides of its external contour which do not provide the pendulum roller track, in conjunction with the wall of the pendulum mass cutout, can serve as a stop for the pendulum masses in the oscillation end region. To this end, the connecting element can be connected to an elastic element, for example a spring element, and/or can be encompassed by elastic material, for example by a rubber reinforcement, in order to lessen the impact for the purpose of wear and noise reduction.

In summary, by integrating the function of providing the pendulum roller tracks which are connected to the pendulum flanges into the connecting element which is provided for interconnecting the pendulum flanges, a more compact centrifugal force pendulum with reduced installation space, parts, material, production time and cost can be provided and as a result of a smaller mass inertia moment and a higher restoring force offers advantages with regard to fuel consumption or oscillation isolation.

The proposed centrifugal force pendulum device or a centrifugal force pendulum, in addition to a separate application in conjunction with a drive train, is suitable as a component in devices such as a torsional oscillation damper, a double clutch, a hydrodynamic torque converter outside and/or inside the converter shell, a friction clutch, a clutch plate and/or a flywheel. The centrifugal force pendulum device is integrated in this case into the corresponding devices. The corresponding devices are therefore expressly covered by the present disclosure.

### BRIEF DESCRIPTION OF THE DRAWINGS

The present disclosure is explained in more detail based on the exemplary embodiments shown in FIGS. 1 to 6. In this case, in the drawing:

FIG. 1 shows a centrifugal force pendulum device in a partially exploded view,

FIG. 2 shows a partial view of the centrifugal force pendulum device of FIG. 1 with the front pendulum flange removed,

FIG. 3 shows a section through the centrifugal force pendulum device of FIG. 2 along the line of intersection B-B,

FIG. 4 shows a section corresponding to FIG. 3 through a centrifugal force pendulum device with a modified connecting means,

FIG. 5 shows the centrifugal force pendulum device of FIGS. 1 to 3 with a deflected pendulum mass in partial view, and

FIG. 6 shows a centrifugal force pendulum device which is modified compared with the centrifugal force pendulum devices of FIGS. 1 to 5.

### DETAILED DESCRIPTION

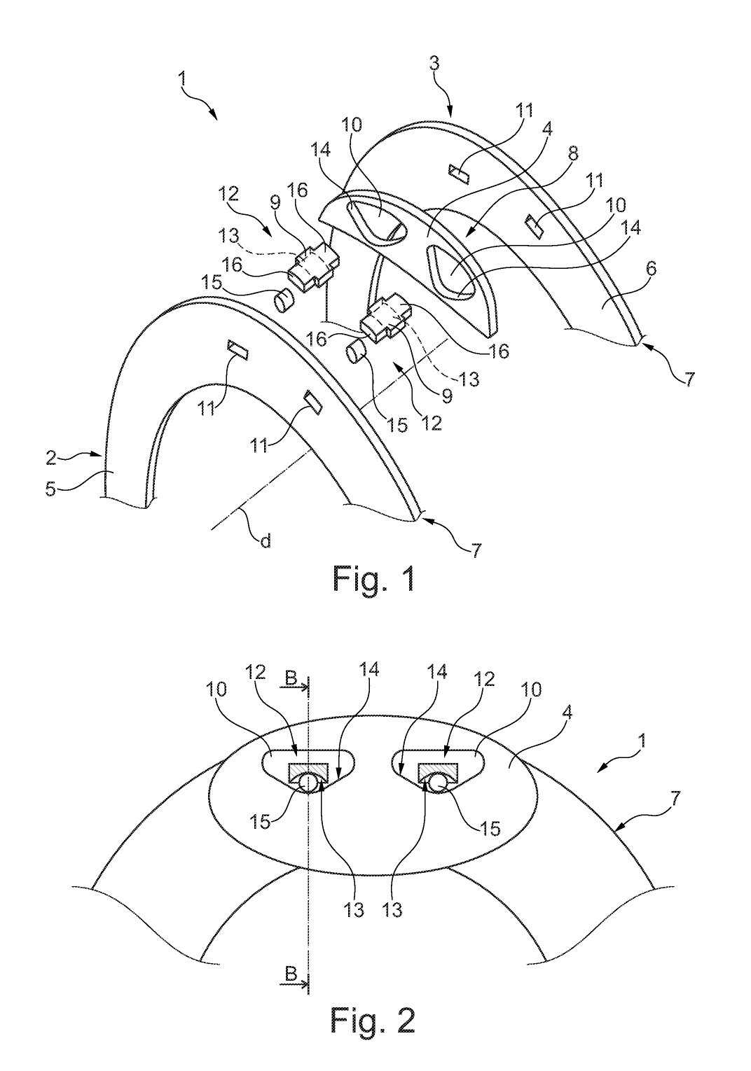

FIG. 1 shows an exploded view of the centrifugal force pendulum device 1 in a partially schematic view. The pendulum elements 2, 3, 4 are in an axially layered, series arrangement with each other and are rotatable around the rotational axis d. In the depicted exemplary embodiment, the annular pendulum elements 2, 3, which are designed as pendulum flanges 5, 6, form the first pendulum unit 7 which is arranged in a radially fixed manner in relation to the rotational axis d and serves as a carrier for the pendulum elements 4 which are arranged over the circumference and form the pendulum masses of the centrifugal force pendulum device 1. The pendulum elements 4 which are arranged in a distributed manner over the circumference, and of which only one is shown, form the second pendulum unit 8.

The pendulum elements 2, 3 axially accommodate the pendulum elements 4 between them and are connected in an axially fixed manner by means of the connecting means 9. To this end, the connecting means 9 pass through recesses 10 or cutouts of the pendulum elements 4 and are pressed and/or introduced in each case by the end into openings 11 of the pendulum elements 2, 3 with angular accuracy and then fixedly connected to the pendulum elements for example by welding, caulking, riveting or in another manner. In the depicted exemplary embodiment, openings 11 and end-face end regions 16 of the connecting means 9 are of rectangular design for the establishing of the angularly accurate forming of the connection. Formed on the connecting means 9, radially on the inside, at the axial height of the pendulum elements 4, is the pendulum roller track 13 which with the complementary pendulum roller track 14 of the recesses 10 and the rolling bodies 15 form a pendulum bearing 12 in each case. By forming the pendulum bearings 12 between connecting means 9 and the pendulum elements 4, the pendulum flanges 5, 6 can be of an axially narrower design with lower strength and lower hardness. Furthermore, the hardening processes of the connecting means 9 can be better implemented than on the pendulum flanges 5, 6. Ensuing as a result of this inter alia are advantages in the production, in the production costs and also, as a result of an improved isolation effect, in the centrifugal force pendulum device 1 since this overall has less mass inertia and an improved ratio between the oscillating, and therefore damping, mass of the pendulum elements 4 and the total mass. Furthermore, advantages can be achieved by reducing the material thickness of the pendulum flanges 5, 6 and/or by increasing the material thickness of the pendulum elements 4 with a comparable or reduced axial installation space of the centrifugal force pendulum device 1.

FIG. 2 shows a partial view of the mounted centrifugal force pendulum device 1 of FIG. 1 in a systematic view, wherein the pendulum flange 5 is removed for the purpose of viewing the pendulum element 4. The pendulum elements 4 are rotatably mounted on the pendulum unit 7 by means of the pendulum bearings 12. The pendulum bearings 12 are formed from the pendulum roller tracks 13, 14, which are machined on the recesses 10 of the pendulum element 4 and on the inner side of the connecting means, and the rolling bodies 15—in this case in the form of pendulum rollers—which roll upon these. In the centrifugal force field of the pendulum unit 7 which rotates around the rotational axis, the pendulum elements 4 are accelerated radially outward, forming the pendulum bearings 12, and occupy their working position. On account of torque fluctuations, these pendulum elements 4 are deflected from this working position along the pendulum roller tracks 13, 14 and therefore damp the torque fluctuations. The design of the pendulum roller tracks, of the shape and mass of the pendulum elements 4 and the like depend on the oscillation order which is to be damped and are correspondingly constructed and designed. For example, all the pendulum elements 4 which are arranged over the circumference can be adapted to a single oscillation order or some of the pendulum elements 4 can be adapted to a first oscillation order and the remainder to a second oscillation order.

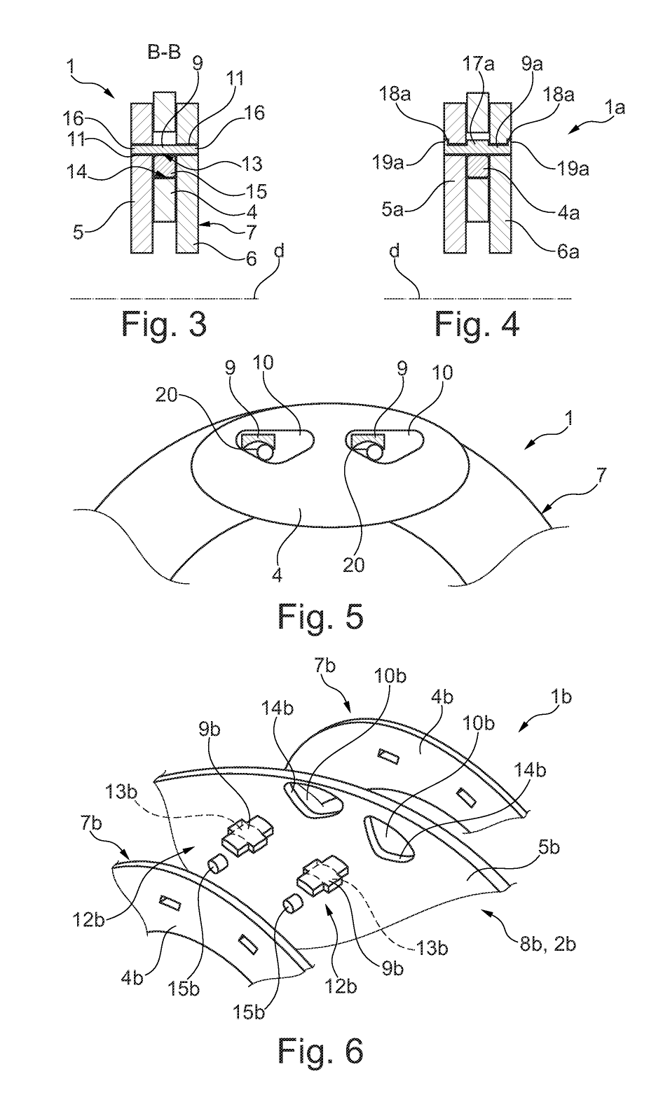

FIG. 3 shows the upper part of the centrifugal force pendulum device 1 which is rotatably arranged around the rotational axis d along the line of intersection B-B of FIG. 2. The pendulum unit 7 accommodates the pendulum elements 4 axially between their pendulum flanges 5, 6. The pendulum flanges 5, 6 which are fixedly interconnected by means of the connecting means 9 have on the connecting means 9 the pendulum roller track 13 for the oscillating mounting of the pendulum elements 4. The rolling body 15 rolls on the pendulum roller track 13 and on the complementary pendulum roller track 14 of the pendulum element 4. The rolling body 15 is accommodated between the pendulum flanges in an axially captively secured manner. The end-face end regions 16 of the connecting means 9 are pressed into the openings 11 of the pendulum flanges 5, 6 in a flush manner in the depicted exemplary embodiment. In contrast to the centrifugal force pendulum device 1 of FIGS. 1 to 3, in FIG. 4 the centrifugal force pendulum device 1a which is shown in the view of FIG. 3 is designed with modified connecting means 9a. In this case, the connecting means 9a are riveted or caulked to the pendulum flanges 5a, 6a. To this end, the connecting means 9a form a collar 17a for providing the axial distance for maintaining a clearance for the pendulum elements 4a. The pendulum flanges 5a, 6a have a widening 18a on the end face for accommodating the material 19a which is displaced during the caulking or riveting or a set head of a riveted connection.

FIG. 5 shows the centrifugal force pendulum device 1 of FIGS. 1 to 4 in the view of FIG. 2 with the pendulum element 4 deflected to the maximum in one direction in relation to the pendulum unit 7. In this case, the connecting means 9 together with the recesses 10 form stops 20 for limiting the oscillation angle of the pendulum elements 4. The stops 20 and/or the recesses 10 can have elastic damping elements at their contact points for the stops 20, for example can be provided elastic material, in order to avoid hard impacts. Alternatively or additionally, spring elements can be provided between these in a way which is not shown.

FIG. 6, in the view corresponding to FIG. 1, shows the centrifugal force pendulum device 1b which is modified compared with the centrifugal force pendulum device 1. In contrast to the centrifugal force pendulum device 1, in the case of the centrifugal force pendulum device 1b provision is made for a single pendulum element 2b in the form of a pendulum flange 5b which forms the second pendulum unit 8b. The pendulum flange 5b is arranged in a radially fixed manner around the rotational axis. The first pendulum unit 7b is formed from the pendulum elements 4b which are arranged on both sides of the pendulum flange 5b. The pendulum elements 4b are arranged in a distributed manner over the circumference, wherein in each case axially opposite pendulum elements 4b are interconnected axially apart by means of the connecting means 9b. To this end, the connecting means 9b pass through recesses 10b of the pendulum flange 5b. The pendulum bearings 12b are formed from the pendulum roller tracks 13b, 14b, which are machined on the connecting means 9b and on the recesses 10b, and also from the rolling bodies 15b. In a corresponding manner to the centrifugal force pendulum device 1, the pendulum elements 4b are radially outwardly supported in relation to the pendulum flange 5b in the centrifugal force field of the pendulum flange 5b which rotates around the rotational axis and are rotatably arranged for damping torque changes such as torsional oscillations.

### LIST OF REFERENCE NUMBERS

1 Centrifugal force pendulum device

1a Centrifugal force pendulum device

1b Centrifugal force pendulum device

2 Pendulum element

2b Pendulum element

3 Pendulum element

4 Pendulum element

4a Pendulum element

4b Pendulum element

5 Pendulum flange

5a Pendulum flange

5b Pendulum flange

6 Pendulum flange

6a Pendulum flange

7 Pendulum unit

7b Pendulum unit

8 Pendulum unit

8b Pendulum unit

9 Connecting means

9a Connecting means

9b Connecting means

10 Recess

10b Recess

11 Opening

12 Pendulum bearing

12b Pendulum bearing

13 Pendulum roller track

13b Pendulum roller track

14 Pendulum roller track

14b Pendulum roller track

15 Rolling body

15b Rolling body

16 End region

17a Collar

18a Widening

19a Material

20 Stop

B-B Line of intersection

d Rotational axis

1.-10. (canceled)

11. A centrifugal force pendulum device, comprising:
a plurality of pendulum elements rotatable around a rotational axis and arranged in an axially layered arrangement, wherein the plurality of pendulum elements includes a first pendulum element, a second pendulum element, and a third pendulum element;
wherein the first pendulum element and the second pendulum element are arranged axially opposite one another to form a first pendulum unit, the first and second pendulum elements being interconnected by a connector; and
wherein the third pendulum element forms a second pendulum unit that is arranged axially between the first and second pendulum elements, the connector being configured to pass through recesses of the second pendulum unit.

12. The centrifugal force pendulum device of claim 11, wherein one of the first pendulum unit or the second pendulum unit is radially fixed in relation to the rotational axis and the other pendulum unit is arranged to oscillate on a pendulum path in relation to the fixed pendulum unit via a pendulum bearing.

13. The centrifugal force pendulum device of claim 12, wherein the pendulum bearing is formed from pendulum roller tracks associated with the first and second pendulum units and from a rolling body configured to roll on the pendulum roller tracks.

14. The centrifugal force pendulum device of claim 11, wherein the first and second pendulum elements of the first pendulum unit are formed from two pendulum flanges that are arranged in a radially fixed manner around the rotational axis and interconnected by the connector.

15. The centrifugal force pendulum device of claim 11, wherein the third pendulum element of the second pendulum unit is formed from a pendulum flange that is arranged in a radially fixed manner around the rotational axis.

16. The centrifugal force pendulum device of claim 11, wherein the connector is introduced into the first, second, and third pendulum elements with angular accuracy.

17. The centrifugal force pendulum device of claim 11, wherein the connector is connected to the first, second, and third pendulum elements in a frictionally engaging, form-fitting, or materially bonding manner.

18. The centrifugal force pendulum device of claim 11, wherein the first pendulum unit is configured to be displaced in an oscillatory manner and have a greater material thickness than the second pendulum unit that is arranged in a radially fixed manner in relation to the rotational axis.

19. The centrifugal force pendulum device of claim 11, wherein the first, second, and third pendulum elements have a lower hardness than the connector.

20. The centrifugal force pendulum device of claim 11, wherein the first, second, and third pendulum elements have a lower strength than the connector.

21. The centrifugal force pendulum device of claim 18, wherein the connector includes a plurality of stops configured to limit an oscillation angle of the first, second, and third pendulum elements against each other.

22. The centrifugal force pendulum device of claim 21, wherein the stops have elastic damping elements.

23. A centrifugal force pendulum device, comprising:
a pendulum carrier including a first pendulum flange and a second pendulum flange rotatable around a rotational axis and arranged axially opposite each other;
a pendulum element disposed axially between the first pendulum flange and the second pendulum flange; and
a connector configured to fixedly connect the pendulum element to the first and second pendulum flanges of the pendulum carrier.

24. The centrifugal force pendulum device of claim 23, wherein:
the first pendulum flange and the second pendulum flange each include an opening;
the pendulum element includes a recess defined therein, wherein the recess is arranged to align with the openings in the first and second pendulum flanges; and
the connector is configured to pass through the recess of the pendulum element and then be introduced into the openings of the first and second pendulum flanges with angular accuracy to fixedly connect the pendulum element to the first and second pendulum flanges.

25. The centrifugal force pendulum device of claim 23, wherein the connector further includes a pendulum roller track formed on a radially inner surface thereof at an axial height of the pendulum element, and wherein a complementary pendulum roller track is formed in a recess of the pendulum element.

26. The centrifugal force pendulum device of claim 25, further including a rolling body configured to roll on the pendulum roller track of the connector and the complementary pendulum roller track of the pendulum element, wherein the pendulum roller track of the connector, the complementary pendulum roller track of the pendulum element, and the rolling body form a pendulum bearing between the connector and the pendulum element.

27. The centrifugal force pendulum device of claim 23, wherein the pendulum carrier is arranged in a radially fixed manner in relation to the rotational axis and the pendulum element is arranged to oscillate on a pendulum path in relation to the pendulum carrier.

28. The centrifugal force pendulum device of claim 23, wherein the pendulum element forms a pendulum mass, and wherein a plurality of pendulum masses are arranged in a distributed manner over a circumference of the pendulum carrier.

29. The centrifugal force pendulum device of claim 23, wherein the connector forms a collar that provides an axial distance for maintaining a clearance for the pendulum element, and wherein the first and second pendulum flanges each have a widening on a respective end face for accommodating material displaced from introducing the connector into openings formed in the first and second pendulum flanges.
